(19) United States
(12) Patent Application Publication
(10) Pub. No.: US 2025/0079034 A1
(43) Pub. Date: Mar. 6, 2025

(54) HELICAL FIBER GEOMETRY FOR CONTINUOUS HIGHER-ORDER MODE STRIPPING IN BEAM DELIVERY FIBERS

(71) Applicant: Quantinuum LLC, Broomfield, CO (US)

(72) Inventor: Bruce Gregory Tiemann, Longmont, CO (US)

(21) Appl. No.: 18/790,723

(22) Filed: Jul. 31, 2024

Related U.S. Application Data
(60) Provisional application No. 63/536,214, filed on Sep. 1, 2023.

(51) Int. Cl. G21K 1/02; B82Y 20/00; G06N 10/20; G06N 10/40

(52) U.S. Cl. CPC G21K 1/025; B82Y 20/00; G06N 10/20; G06N 10/40

(57) ABSTRACT

Example embodiments provide quantum computers, laser light delivery systems for quantum computers, and methods for delivering laser light from lasers of quantum computers to atomic object confinement apparatuses of quantum computers. In an example embodiment, a quantum computer comprises an atomic object confinement apparatus, a laser, a cylindrical guide positioned such that a first end of the cylindrical guide is adjacent the laser and a second end of the cylindrical guide is adjacent the atomic object confinement apparatus, and an optical fiber cable helically wrapped around the cylindrical guide and spanning from the first end to the second end. The optical fiber cable is configured to deliver laser light generated by the laser to the atomic object confinement apparatus. A pitch of the helically wrapped optical fiber cable is selected to provide a desired effective bend radius of the optical fiber cable to strip higher-order modes of the laser light.

### CROSS-REFERENCE TO RELATED APPLICATIONS

This application claims priority to and the benefit of U.S. Provisional Patent Application Ser. No. 63/536,214, filed on Sep. 1, 2023, and titled “HELICAL FIBER GEOMETRY FOR CONTINUOUS HIGHER-ORDER MODE STRIPPING IN BEAM DELIVERY FIBERS,” which is incorporated herein by reference in its entirety.

### TECHNICAL FIELD

Various embodiments relate generally to optical fiber for laser beam delivery, and more specifically to continuous higher-order mode stripping in optical fiber for laser beam delivery.

### BACKGROUND

Optical fiber cables are often used as a waveguide for delivering laser light from a laser to a destination. In many applications, it is desirable to have the laser light propagate through the optical fiber cable in a single mode. Multimode propagation might result in internal interferometers inside a fiber, resulting in unexpected phase or intensity transmission. In such applications in which multimode propagation is undesirable, it is often possible to obtain single mode optical fiber cables for the wavelength of light being propagated. However, in some shorter wavelength applications, such single mode optical fiber cable may not be readily available. For example, some quantum computing operations use laser light in the 360-370 nanometer range. Single mode optical fiber cable may not be readily available with immediate lead time at such wavelengths.

Through applied effort, ingenuity, and innovation, many deficiencies of prior laser beam delivery systems and methods have been solved by developing solutions that are structured in accordance with the embodiments of the present invention, many examples of which are described in detail herein.

### BRIEF SUMMARY OF EXAMPLE EMBODIMENTS

Example embodiments provide quantum computers, laser light delivery systems for quantum computers, and methods for delivering laser light from lasers of quantum computers to atomic object confinement apparatuses of quantum computers.

In an example embodiment, and according to an aspect of the present disclosure, a quantum computer comprises an atomic object confinement apparatus, a laser, a cylindrical guide positioned such that a first end of the cylindrical guide is adjacent the laser and a second end of the cylindrical guide is adjacent the atomic object confinement apparatus, and an optical fiber cable helically wrapped around the cylindrical guide and spanning from the first end to the second end of the cylindrical guide. The optical fiber cable is configured to deliver laser light generated by the laser to the atomic object confinement apparatus. A pitch of the helically wrapped optical fiber cable is selected to provide a desired effective bend radius of the optical fiber cable to strip higher-order modes of the laser light.

In an example embodiment, the cylindrical guide is constructed of a rigid material.

In an example embodiment, the cylindrical guide is constructed of a hollow material.

In an example embodiment, the cylindrical guide is constructed as a single, unitary piece.

In an example embodiment, the optical fiber cable is a first optical fiber cable and the quantum computer further comprises a second optical fiber cable helically wrapped around the cylindrical guide in a multifilar arrangement with the first optical fiber cable and spanning from the first end to the second end of the cylindrical guide. The second optical fiber cable is configured to deliver laser light generated by the laser to the atomic object confinement apparatus.

In an example embodiment, the optical fiber cable is a first optical fiber cable and the quantum computer further comprises a plurality of optical fiber cables bundled together with the first optical fiber cable. The plurality of optical fiber cables is configured to deliver laser light generated by the laser to the atomic object confinement apparatus. The bundled plurality of optical fiber cables and the first optical fiber cable are helically wrapped around the cylindrical guide spanning from the first end to the second end of the cylindrical guide.

In an example embodiment, the plurality of optical fiber cables and the first optical fiber cable are bundled in a single layer.

In an example embodiment, the plurality of optical fiber cables and the first optical fiber cable are bundled in two or more layers.

In an example embodiment, the quantum computer further comprises a mounting fixture affixed to and projecting from the cylindrical guide adapted to secure the cylindrical guide to an adjacent structure. The pitch of the helically wrapped optical fiber cable is selected to provide sufficient spacing for the mounting fixture to protrude between two adjacent coils of the optical fiber cable.

In an example embodiment, the quantum computer further comprises two or more lasers, two or more optical fiber cables configured to deliver laser light generated by the two or more lasers to the atomic object confinement apparatus, and two or more cylindrical guides positioned such that a first end of a respective cylindrical guide is positioned adjacent a respective laser and a second end of a respective cylindrical guide is positioned adjacent the atomic object confinement apparatus. Each of the optical fiber cables is helically wrapped around a respective cylindrical guide spanning from the first end to the second end of the respective cylindrical guide.

According to another aspect of the present disclosure, a laser light delivery system for a quantum computer comprises a cylindrical guide adapted to be positioned such that a first end of the cylindrical guide is adjacent a laser of the quantum computer and a second end of the cylindrical guide is adjacent an atomic object confinement apparatus of the quantum computer and an optical fiber cable helically wrapped around the cylindrical guide and spanning from the first end to the second end of the cylindrical guide. The optical fiber cable is adapted to deliver laser light generated by the laser to the atomic object confinement apparatus. A pitch of the helically wrapped optical fiber cable is selected to provide a desired effective bend radius of the optical fiber cable to strip higher-order modes of the laser light.

According to another aspect of the present disclosure, a method of delivering laser light from a laser of a quantum computer to an atomic object confinement apparatus of the quantum computer comprises: positioning a cylindrical guide such that a first end of the cylindrical guide is adjacent the laser of the quantum computer and a second end of the cylindrical guide is adjacent the atomic object confinement apparatus of the quantum computer; and helically wrapping an optical fiber cable around the cylindrical guide from the first end to the second end of the cylindrical guide, the optical fiber cable adapted to deliver laser light generated by the laser to the atomic object confinement apparatus. A pitch of the helically wrapped optical fiber cable is selected to provide a desired effective bend radius of the optical fiber cable to strip higher-order modes of the laser light.

According to another aspect of the present disclosure, a laser light delivery system comprises a cylindrical guide adapted to be positioned such that a first end of the cylindrical guide is adjacent a laser light source and a second end of the cylindrical guide is adjacent a laser light destination and an optical fiber cable helically wrapped around the cylindrical guide and spanning from the first end to the second end of the cylindrical guide. The optical fiber cable is adapted to deliver laser light generated by the laser light source to the laser light destination. A pitch of the helically wrapped optical fiber cable is selected to provide a desired effective bend radius of the optical fiber cable to strip higher-order modes of the laser light.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising a quantum system controller according to an example embodiment.

FIG. 2 provides a schematic diagram of an example quantum computing system with helically wrapped optical fiber cables according to an example embodiment.

FIGS. 3A and 3B illustrate various lengths and angles of a helically wrapped optical fiber cable according to an example embodiment.

FIG. 4 illustrates a portion of two helically wrapped optical fiber cables according to an example embodiment.

FIG. 5 illustrates a cross-section of a portion of a bundle of helically wrapped optical fiber cables according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Various embodiments of the present disclosure provide quantum computers, laser beam delivery systems, and methods for delivering laser light in which laser light is delivered from a laser to the physics package (containing, for example, an atomic object confinement apparatus) of a quantum computer while continuously stripping the higher-order modes from the fiber, preventing the formation of unwanted internal interferometers.

Various embodiments wrap the optical fiber cable in a loose helix (i.e., such that the coils of the helically wrapped optical fiber cable are not touching each other) around a small-diameter cylindrical guide that is long enough to physically route the optical fiber cable from the laser to the physics package. In various embodiments, the cylindrical guide is a small diameter (e.g., 0.5-1.0 inch diameter, although any suitable diameter may be used) rod or pipe, which may be solid or hollow. In various embodiments, the cylindrical guide has a cross-section perpendicular to its longitudinal axis that is circular, elliptical, oval, or the like. The continuous helical turns of the optical fiber cable along the length of the cylindrical guide means that the optical fiber cable is continuously curved along its entire length and is therefore continuously stripping any higher-order modes that develop and continuously preventing any interferometers from developing, while carrying the cable from the laser light source to the laser light destination.

In various embodiments, the effective bend radius of the optical fiber cable can be selected by selecting the pitch of the helically wrapped optical fiber cable. The pitch of the helically wrapped optical fiber cable is defined as the distance between two adjoining coils at the points where each adjoining coil crosses an imaginary longitudinal line on the surface of the cylindrical guide. The use of a helically wrapped optical fiber cable enables any suitable effective bend radius of the cable to be selected, from just slightly greater than the radius of the cylindrical guide up to infinity. Because any suitable effective bend radius of the cable is enabled by selecting the pitch, it is not necessary to use cylindrical guides with different diameters to obtain different bend radii.

Generally, a smaller effective bend radius more effectively strips the higher-order modes but requires more optical fiber cable to span from the laser to the physics package, while a larger effective bend radius is less effective at stripping the higher-order modes but requires less optical fiber cable to span from the laser to the physics package. Fairly small increases in the effective bend radius significantly reduce the amount of optical fiber cable needed. Additionally, the use of helically wrapped optical fiber cable enables the radius of the cylindrical guide to be much less than the minimum bend radius of the optical fiber cable. For example, an optical fiber cable with a minimum bend radius of five centimeters can be helically wrapped around a cylindrical guide with a 0.5 centimeter radius since the pitch of the optical fiber cable can be selected to provide a five centimeter (or greater) effective bend radius.

In various embodiments, the cylindrical guide need not be continuously straight, as the helically wrapped optical fiber cable can bend in its overall direction of travel (along any axis or plane). For example, in some embodiments the cylindrical guide may be gently curved at one or more places along its length. As another example, in some embodiments the cylindrical guide may be continuously curved/bent along its entire length. This enables the cylindrical guide to be routed as needed along a desired pathway (for example, along an optical table but avoiding obstacles, and then up a ramp to a different optical assembly).

In various embodiments, the optical fiber cable can be helically wrapped around the cylindrical guide after emplacement of the guide in its desired location. In various embodiments, the cylindrical guide may be constructed as a single, unitary component. In various alternative embodiments, the cylindrical guide may have a multi-piece construction. For example, the cylindrical guide may be constructed of two or more straight sections (which may have different lengths) that are joined together with one or more couplers that provide a desired angle between the two adjoined straight sections. In some embodiments, different couplers with different angles may be available. In some embodiments, it is necessary that any bends/curves in the cylindrical guide be gentle enough that the effective bend radius of the optical fiber cable is not significantly altered by the bends/curves in the guide, and, in particular, that no sharp bends are made that would force a helically-wrapped optical fiber cable to have a local bend radius that is less than the optical fiber cable's safe minimum bend radius.

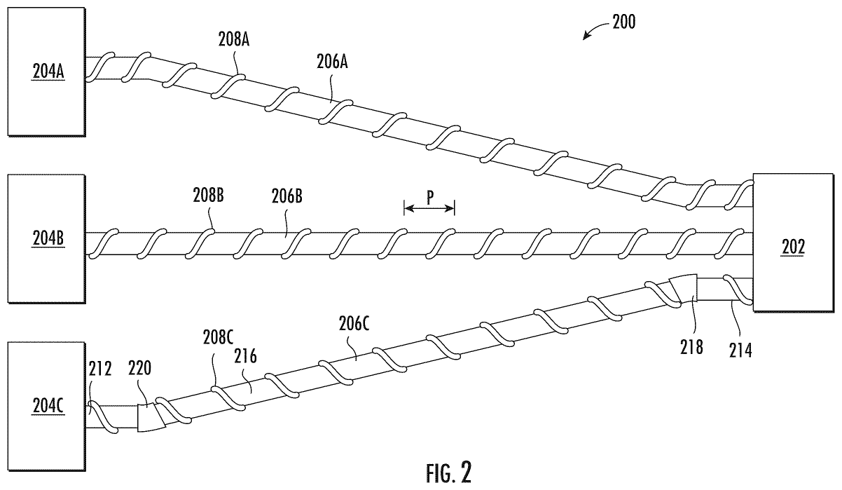

The optical fiber cable being wrapped around the cylindrical guide in a loose helix means that, at a minimum, the coils of the optical fiber cable are not touching each other. In other words, the pitch of the wrapped cable is at least greater than the diameter of the cable. However, since the cable becomes become effectively wider by its slant, the pitch of the wrapped cable should be at least greater than the diameter of the cable multiplied by the cosine of the angle of the cable relative to a plane that is perpendicular to the longitudinal axis of the guide (this angle is termed the “base included angle”) in order for its coils to not be touching each other. In various embodiments, the pitch of the wrapped cable is much greater than the diameter of the cable. For example, in the embodiment illustrated in FIG. 2, the pitch of the wrapped cable is about seven times the diameter of the cable.

In various embodiments, the spacing between the coils of the helically wrapped optical fiber cable enables one or more support posts, brackets, or the like to be attached at one end to the cylindrical guide and attached at an opposite end to adjacent structure to provide support and rigidity to the cylindrical guide. Such rigidity provided by the support posts, in addition to the inherent rigidity of the cylindrical guide, helps reduce or prevent extraneous movement of the cylindrical guide and therefore of the optical fiber cable which can induce undesirable time-dependent intensity and time-dependent phase shifts.

In various embodiments, two or more optical fiber cables may be helically wrapped around one cylindrical guide in a multifilar arrangement. This is useful with, for example, quantum computers having multiple gate zones and/or two qubit gates. For example, in quantum computer with five gates zones, each having a two qubit gate, ten optical fiber cables would need to be routed from the laser to the gate zones. In such an example embodiments, ten optical fiber cables can be helically wrapped around one cylindrical guide to route all ten cables while continuously stripping any higher-order modes and preventing any interferometers from developing in the ten cables.

In various embodiments, any number of optical fiber cables can be helically wrapped around a cylindrical guide, up to a maximum number at which neither interference-free mounting nor helicity is possible. In some embodiments, the maximum number of fibers possible in a single layer is the ratio of the effective guide circumference to the optical fiber cable diameter, which is 2 pi x (guide radius+cable radius)/(cable diameter), noting that this is an absolute limit. As described above, the optical fiber cables become effectively wider by their slant, so the maximum carrying capacity of the cylindrical guide would be reduced by multiplying the above result by the cosine of the base included angle. In some embodiments, the calculated capacity might need to be reduced by one or more optical fiber cables to allow spacing for mounting hardware. In a specific example embodiment, a cylindrical guide with a 0.5 inch (12.7 millimeter (mm)) diameter being wrapped with 3 mm diameter jacketed optical fiber cables would have a maximum capacity of sixteen cables in a single layer around the circumference of the cylindrical guide, not including accommodations for helicity nor for mounting gaps. While sixteen cables would likely be too crowded, such a cylindrical guide carrying, for example, five or ten optical fiber cables would allow spacing for mounting hardware and would enable a non-zero helicity of the optical fiber cables.

In various embodiments, cable-carrying capacity on a single cylindrical guide can be increased by stacking multiple layers of optical fiber cables with the same helical pitch. In such embodiments, for example, the optical fiber cables in an outer layer would sit in grooves formed between pairs of optical fiber cables in an inner layer. However, in some embodiments such stacking has one or more disadvantages. For example, such stacking means that some optical fiber cables would be buried beneath other optical fiber cables. Further, such stacking means that the optical fiber cables on subsequent (i.e., outer) layers would have a larger effective bend radius (which may be less effective at higher-order mode stripping) for the same helical pitch because of the larger effective cylindrical guide diameter due to the added diameter of the inner layer optical fiber cables.

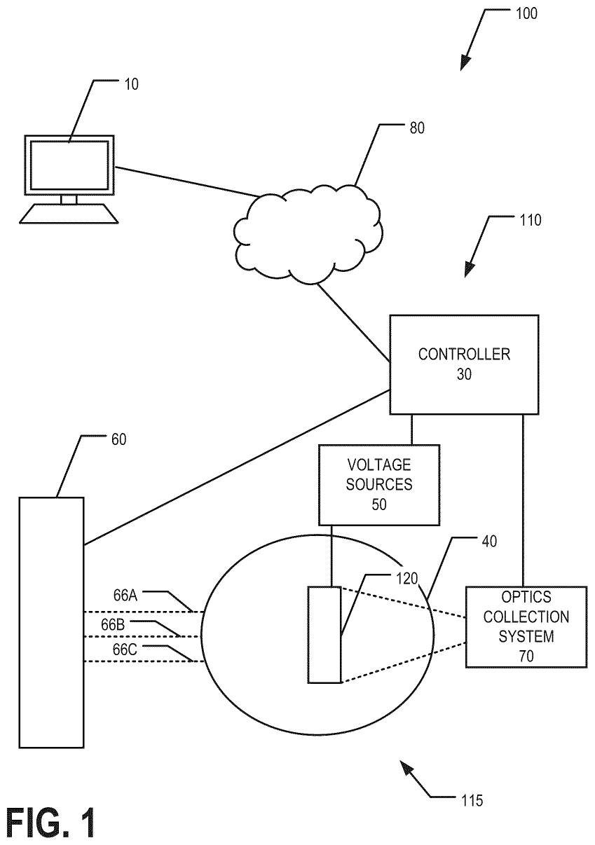

In various embodiments, the single-mode laser light delivery system may be used in a quantum computing system, such as the quantum computing system 100 depicted in FIG. 1. FIG. 1 provides a schematic diagram of an example quantum computing system 100 where the quantum processor comprises an atomic object confinement apparatus 120 (e.g., an ion trap and/or the like) having a plurality of atomic objects (e.g., atoms, ions, and/or the like) confined therein, in accordance with an example embodiment. In various embodiments, the quantum computing system 100 comprises a computing entity 10 and a quantum computer 110. In various embodiments, the quantum computer 110 comprises a quantum system controller 30 and a quantum processor 115. In various embodiments, the quantum system controller 30 is configured, programmed, and/or the like to control the quantum processor 115. In an example embodiment, the quantum processor 115 comprises a plurality of qubits (e.g., data qubits that may be organized into logical qubits, ancilla qubits, and/or the like). In various embodiments, the quantum computer 110 includes or communicates with databases (not shown) described herein. For example, the databases may be stored by one or more computing entities 10 that are in communication with the controller 30 via one or more wired and/or wireless networks 80 and/or stored by memory local to the controller 30.

In various embodiments, the quantum processor 115 comprises means for controlling the evolution of quantum states of the qubits. For example, in an example embodiment, the quantum processor 115 comprises a cryostat and/or vacuum chamber 40 enclosing a confinement apparatus 120 (e.g., an ion trap), one or more manipulation sources 60, one or more voltage sources 50, and/or one or more optics collection systems 70. For example, the cryostat and/or vacuum chamber 40 may be a temperature and/or pressure-controlled chamber. In an example embodiment, the manipulation signals generated by the manipulation sources 60 are provided to the interior of the cryostat and/or vacuum chamber 40 (where the atomic object confinement apparatus 120 is located) via corresponding optical paths 66 (e.g., 66A, 66B, 66C). In an example embodiment, the one or more manipulation sources 60 may comprise one or more lasers (e.g., optical lasers, microwave sources, and/or the like). In various embodiments, the one or more manipulation sources 60 are configured to manipulate and/or cause a controlled quantum state evolution of one or more atomic objects within the confinement apparatus. In various embodiments, the atomic objects within the atomic confinement apparatus (e.g., ions trapped within an ion trap) act as the data qubits and/or ancilla qubits of the quantum processor 115 of the quantum computer 110. For example, in an example embodiment, wherein the one or more manipulation sources 60 comprise one or more lasers, the lasers may provide one or more laser beams to atomic objects trapped within the confinement apparatus 120 within the cryostat and/or vacuum chamber 40. For example, the manipulation sources 60 may generate and/or provide laser beams configured to ionize atomic objects, initialize atomic objects within the defined two state qubit space of the quantum processor, perform gating on one or more qubits of the quantum processor, read a quantum state of one or more qubits of the quantum processor, and/or the like.

In various embodiments, the quantum computer 110 comprises an optics collection system 70 configured to collect and/or detect photons generated by qubits (e.g., during reading procedures). The optics collection system 70 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer 110. In various embodiments, the detectors may be in electronic communication with the quantum system controller 30 via one or more A/D converters (not illustrated) and/or the like.

In various embodiments, the quantum computer 110 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 120, in an example embodiment. Varying the electrical potential(s) may move the ions between locations or states. In various embodiments, how to vary the electrical potential(s) may be defined by waveforms that specify one or more voltages to apply over a period of time. In various embodiments, the one or more voltage source 50 may be coupled to electrodes via circuitry including one or more high-voltage semiconductor switches. The circuitry coupling the voltage sources 50 to the electrodes may also include circuitry providing bias voltages, such as to a gate of one or more FETs in one or more of the high-voltage semiconductor switches. The circuity coupling the voltage sources 50 the electrodes may also include circuitry connecting one or more voltage sources to the gates and/or drains of the one or more FETs in one or more of the high-voltage semiconductor switches. In various embodiments, the circuity coupling the voltage sources 50 the electrodes may be located outside the cryostat and/or vacuum chamber 40, inside the cryostat and/or vacuum chamber 40, or both inside and outside the cryostat and/or vacuum chamber 40. In embodiments where the circuitry coupling the voltage sources 50 to the electrodes is located in the cryostat and/or vacuum chamber 40, the high-voltage semiconductor switch may be located in the cryostat and/or vacuum chamber 40. In various embodiments the circuity coupling the voltage sources 50 to the electrodes, including the one or more high-voltage semiconductor switches, will be comprised of circuit components capable of and/or configured to operate at the temperatures for their location, such as those in the cryostat and/or vacuum chamber, which may have temperatures below 4 Kelvin.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the quantum system controller 30 of the quantum computer 110 via one or more wired or wireless networks 80 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the quantum system controller 30 can understand and/or implement. For example, the controller 30 is configured to generate machine code level commands configured to, when executed by the appropriate components of the quantum computer 110, cause the performance of a quantum circuit by the quantum computer 110. In various embodiments, the performance of a quantum circuit may include providing and/or controlling voltages to one or more terminals of a high-voltage semiconductor switch, which may control how the high-voltage semiconductor switch provides voltage to one or more electrodes.

In various embodiments, the quantum system controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, and/or the like) within the cryostat and/or vacuum chamber 40 and/or configured to manipulate and/or cause a controlled evolution of quantum states of one or more atomic objects within the confinement apparatus. For example, the quantum system controller 30 may cause a controlled evolution of quantum states of one or more atomic objects within the confinement apparatus to execute a quantum circuit and/or algorithm. For example, the quantum system controller 30 may cause a reading procedure comprising coherent shelving to be performed, possibly as part of executing a quantum circuit and/or algorithm. Additionally, the quantum system controller 30 is configured to communicate and/or receive input data from the optics collection system 70 and corresponding to the reading of the quantum state of qubits of the quantum computer 110. In various embodiments, the atomic objects confined within the confinement apparatus are used as qubits of the quantum computer 110.

In various embodiments, a quantum computer 110 comprises a quantum system controller 30 and a quantum processor 115. The quantum system controller 30 is configured to control various components of a quantum processor 115.

In various embodiments, the quantum system controller 30 is in communication with an optics collection system 70 such that the quantum system controller 30 is configured to receive input data captured and/or generated by the optics collection system 70. In various embodiments, the quantum system controller 30 is further configured to control a cryostat system and/or vacuum system controlling the temperature and pressure within the cryostat and/or vacuum chamber 40, cooling system, and/or other systems controlling the environmental conditions (e.g., temperature, humidity, pressure, and/or the like) within the cryostat and/or vacuum chamber 40.

FIG. 2 illustrates an example quantum computing system with helically wrapped optical fiber cables according to an example embodiment. Some components of an example quantum computing system are omitted from FIG. 2 for simplicity. FIG. 2 illustrates an example quantum computing system 200 having three lasers 204A, 204B, 204C providing laser light to a physics package 202 via, respectively, optical fiber cables 208A, 208B, 208C. As illustrated in FIG. 2, each of the optical fiber cables 208A, 208B, 208C is helically wrapped around a respective cylindrical guide 206A,206B, 206C. As described above, the pitch (shown in FIG. 2 as “P”) of each of the optical fiber cables 208A, 208B, 208C may be selected to provide the desired effective bend radius. The same pitch may be used for each of the optical fiber cables, or two or more different pitches may be used. As seen in FIG. 2, each of the helically wrapped optical fiber cables 208A, 208B, 208C spans from a respective one of the lasers 204A, 204B, 204C to the physics package 202, with a continuous curvature. The cylindrical guide 206B is straight along its entire length, while the cylindrical guides 206A, 206C each have straight portions and curved portions. The cylindrical guides 206A, 206B are constructed as single, unitary components, while the cylindrical guide 206C has a multi-piece construction with straight segments 212, 214, 216 and curved couplers 218, 220 that provide a desired angle between two adjoined straight sections.

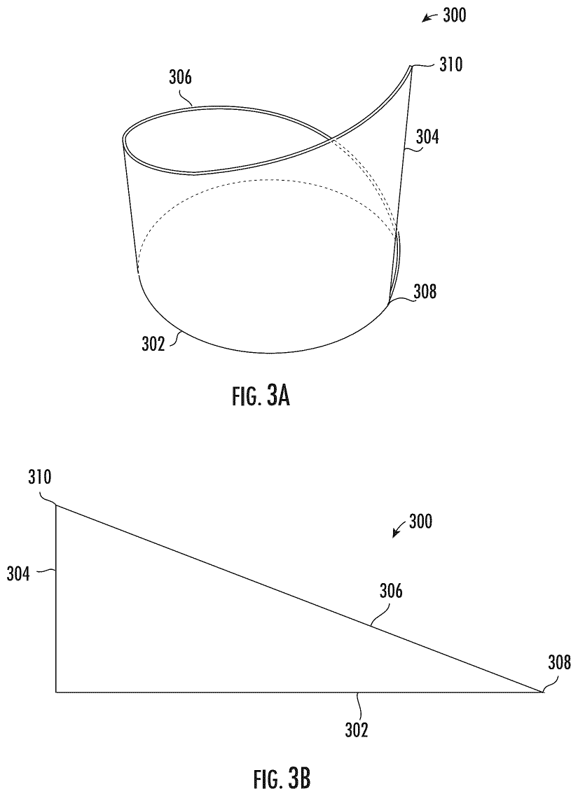

FIGS. 3A and 3B illustrate various lengths and angles of a helically wrapped optical fiber cable according to an example embodiment. The increased length of fiber needed to support a given helical pitch can be easily understood as a right triangle wrapped around the guide. FIG. 3A illustrates such a right triangle represented as if wrapped around a cylindrical guide, while FIG. 3B illustrates such a right triangle “unwrapped” from a cylindrical guide and flattened. The right triangle 300 comprises a base leg 302 representing the circumference of the wraps of cable (calculated as 2 pi x (guide radius+cable radius)), a pitch leg 304 representing the length along the guide for one turn of the helix, and a hypotenuse 306 representing the length of optical fiber cable needed for one coil. If the helix pitch is much longer than the diameter of the cylindrical guide, then this right triangle will be very acute, with the base included angle 308 approaching 90 degrees, the pitch included angle 310 approaching zero, and the hypotenuse 306 only slightly longer than the pitch leg 304 (thus illustrating why not much extra cable length would be needed in such a case compared to a straight cable traversing the same path).

Once such a right triangle has been calculated, the effective bend radius is given by considering the guide being sliced by a plane that is inclined at the base included angle 308. Neglecting the cable diameter, this slice produces an elliptical cross section of the guide with a semi-minor axis of just the guide's radius, and with a semi-major axis that is the secant of the base included angle times the guide's radius. The cable's effective bend radius in the 3-D helix can be approximated by the radius of curvature of this 2-D ellipse, which is the square of this secant times the guide's radius, or times (guide radius+cable radius) if the cable radius is not negligible. Because the effective bend diameter approaches infinity at longer helix pitches, the guide's radius can safely be much less than the cable's minimum safe bend radius, and any desired cable bend radius from the safe minimum to infinity can be selected by altering the helix pitch.

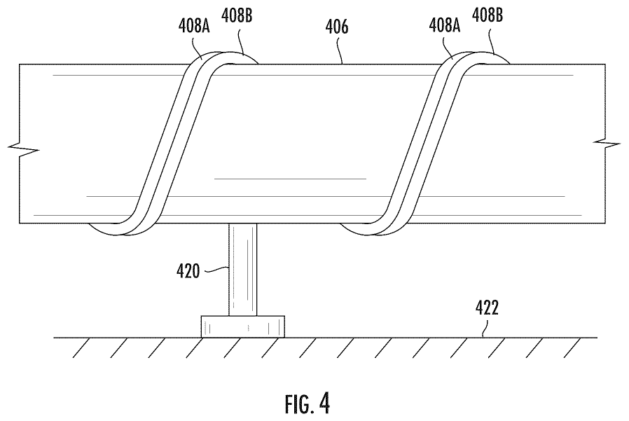

As described above, two or more optical fiber cables may be helically wrapped around one cylindrical guide in a multifilar arrangement. FIG. 4 illustrates a portion of two helically wrapped optical fiber cables according to an example embodiment. As illustrated in FIG. 4, a first optical fiber cable 408A and a second optical fiber cable 408B are helically wrapped around a cylindrical guide 406 in a multifilar arrangement. In the embodiment illustrated in FIG. 4, the first optical fiber cable 408A and the second optical fiber cable 408B are positioned such that they abut each other. In alternative embodiments, the two optical fiber cables may be positioned apart from each other. In the embodiment illustrated in FIG. 4, the pitch of the first optical fiber cable 408A and the second optical fiber cable 408B is selected to provide sufficient spacing between the coils for a mounting post 420 to extend outward from the cylindrical guide 406 to secure the cylindrical guide 406 and the optical fiber cables 408A, 408B to an adjacent structure 422.

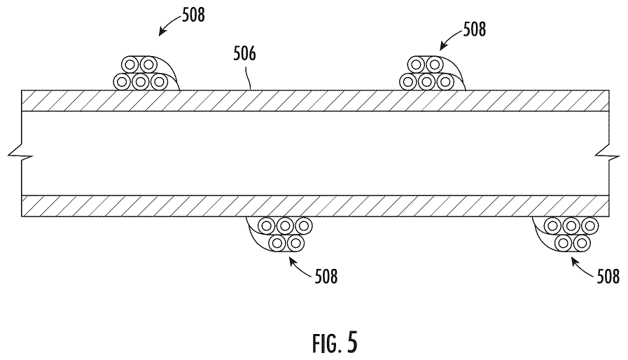

As described above, multiple optical fiber cables may be stacked in two or more layers on a cylindrical guide. FIG. 5 illustrates a cross-section of a portion of a bundle of stacked helically wrapped optical fiber cables according to an example embodiment. As illustrated in FIG. 5, a bundle 508 of five optical fiber cables are helically wrapped around a cylindrical guide 506. The two optical fiber cables in the outer layer sit in grooves formed between pairs of the three optical fiber cables in the inner layer.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A quantum computer comprising:
an atomic object confinement apparatus;
a laser;
a cylindrical guide positioned such that a first end of the cylindrical guide is adjacent the laser and a second end of the cylindrical guide is adjacent the atomic object confinement apparatus; and
an optical fiber cable helically wrapped around the cylindrical guide and spanning from the first end to the second end of the cylindrical guide, the optical fiber cable configured to deliver laser light generated by the laser to the atomic object confinement apparatus;
wherein a pitch of the helically wrapped optical fiber cable is selected to provide a desired effective bend radius of the optical fiber cable to strip higher-order modes of the laser light.

2. The quantum computer of claim 1, wherein the optical fiber cable is a first optical fiber cable, and
wherein the quantum computer further comprises a second optical fiber cable helically wrapped around the cylindrical guide in a multifilar arrangement with the first optical fiber cable and spanning from the first end to the second end of the cylindrical guide, the second optical fiber cable configured to deliver laser light generated by the laser to the atomic object confinement apparatus.

3. The quantum computer of claim 1, wherein the optical fiber cable is a first optical fiber cable;
wherein the quantum computer further comprises a plurality of optical fiber cables bundled together with the first optical fiber cable, the plurality of optical fiber cables configured to deliver laser light generated by the laser to the atomic object confinement apparatus; and
wherein the bundled plurality of optical fiber cables and the first optical fiber cable are helically wrapped around the cylindrical guide spanning from the first end to the second end of the cylindrical guide.

4. The quantum computer of claim 3, wherein the plurality of optical fiber cables and the first optical fiber cable are bundled in a single layer.

5. The quantum computer of claim 3, wherein the plurality of optical fiber cables and the first optical fiber cable are bundled in two or more layers.

6. The quantum computer of claim 1, further comprising a mounting fixture affixed to and projecting from the cylindrical guide adapted to secure the cylindrical guide to an adjacent structure;
wherein the pitch of the helically wrapped optical fiber cable is selected to provide sufficient spacing for the mounting fixture to protrude between two adjacent coils of the optical fiber cable.

7. The quantum computer of claim 1, further comprising:
two or more lasers;
two or more optical fiber cables configured to deliver laser light generated by the two or more lasers to the atomic object confinement apparatus; and
two or more cylindrical guides positioned such that a first end of a respective cylindrical guide is positioned adjacent a respective laser and a second end of a respective cylindrical guide is positioned adjacent the atomic object confinement apparatus;
wherein each of the two or more optical fiber cables is helically wrapped around a respective cylindrical guide spanning from the first end to the second end of the respective cylindrical guide.

8. A laser light delivery system for a quantum computer, the laser light delivery system comprising:
a cylindrical guide adapted to be positioned such that a first end of the cylindrical guide is adjacent a laser of the quantum computer and a second end of the cylindrical guide is adjacent an atomic object confinement apparatus of the quantum computer; and
an optical fiber cable helically wrapped around the cylindrical guide and spanning from the first end to the second end of the cylindrical guide, the optical fiber cable adapted to deliver laser light generated by the laser to the atomic object confinement apparatus;
wherein a pitch of the helically wrapped optical fiber cable is selected to provide a desired effective bend radius of the optical fiber cable to strip higher-order modes of the laser light.

9. The laser light delivery system of claim 8, wherein the optical fiber cable is a first optical fiber cable, and
wherein the laser light delivery system further comprises a second optical fiber cable helically wrapped around the cylindrical guide in a multifilar arrangement with the first optical fiber cable and spanning from the first end to the second end of the cylindrical guide, the second optical fiber cable adapted to deliver laser light generated by the laser to the atomic object confinement apparatus.

10. The laser light delivery system of claim 8, wherein the optical fiber cable is a first optical fiber cable;
wherein the laser light delivery system further comprises a plurality of optical fiber cables bundled together with the first optical fiber cable, the plurality of optical fiber cables adapted to deliver laser light generated by the laser to the atomic object confinement apparatus; and
wherein the bundled plurality of optical fiber cables and the first optical fiber cable are helically wrapped around the cylindrical guide and span from the first end to the second end of the cylindrical guide.

11. The laser light delivery system of claim 10, wherein the plurality of optical fiber cables and the first optical fiber cable are bundled in a single layer.

12. The laser light delivery system of claim 10, wherein the plurality of optical fiber cables and the first optical fiber cable are bundled in two or more layers.

13. The laser light delivery system of claim 8, further comprising a mounting fixture affixed to and projecting from the cylindrical guide adapted to secure the cylindrical guide to an adjacent structure;
wherein the pitch of the helically wrapped optical fiber cable is selected to provide sufficient spacing for the mounting fixture to protrude between two adjacent coils of the optical fiber cable.

14. The laser light delivery system of claim 8, further comprising:
two or more optical fiber cables adapted to deliver laser light generated by two or more lasers of the quantum computer to the atomic object confinement apparatus of the quantum computer; and
two or more cylindrical guides adapted to be positioned such that a first end of a respective cylindrical guide is adjacent a respective laser and a second end of a respective cylindrical guide is adjacent the atomic object confinement apparatus;
wherein each of the two or more optical fiber cables is helically wrapped around a respective cylindrical guide spanning from the first end to the second end of the respective cylindrical guide.

15. A method of delivering laser light from a laser of a quantum computer to an atomic object confinement apparatus of the quantum computer, the method comprising:
positioning a cylindrical guide such that a first end of the cylindrical guide is adjacent the laser of the quantum computer and a second end of the cylindrical guide is adjacent the atomic object confinement apparatus of the quantum computer; and
helically wrapping an optical fiber cable around the cylindrical guide from the first end to the second end of the cylindrical guide, the optical fiber cable adapted to deliver laser light generated by the laser to the atomic object confinement apparatus;
wherein a pitch of the helically wrapped optical fiber cable is selected to provide a desired effective bend radius of the optical fiber cable to strip higher-order modes of the laser light.

16. The method of claim 15, wherein the optical fiber cable is a first optical fiber cable, and
wherein the method further comprises helically wrapping a second optical fiber cable around the cylindrical guide in a multifilar arrangement with the first optical fiber cable from the first end to the second end of the cylindrical guide, the second optical fiber cable adapted to deliver laser light generated by the laser to the atomic object confinement apparatus.

17. The method of claim 15, wherein the optical fiber cable is a first optical fiber cable; and
wherein the method further comprises helically wrapping a plurality of optical fiber cables bundled together with the first optical fiber cable around the cylindrical guide, the plurality of optical fiber cables adapted to deliver laser light generated by the laser to the atomic object confinement apparatus.

18. The method of claim 17, wherein the plurality of optical fiber cables and the first optical fiber cable are bundled in a single layer or are bundled in two or more layers.

19. The method of claim 15, further comprising securing the cylindrical guide to an adjacent structure via a mounting fixture affixed to and projecting from the cylindrical guide;
wherein the pitch of the helically wrapped optical fiber cable is selected to provide sufficient spacing for the mounting fixture to protrude between two adjacent coils of the optical fiber cable.

20. The method of claim 15, wherein the optical fiber cable is a first optical fiber cable;
wherein the cylindrical guide is a first cylindrical guide:
wherein the method further comprises:
positioning a second cylindrical guide such that a first end of the second cylindrical guide is adjacent the laser of the quantum computer and a second end of the second cylindrical guide is adjacent the atomic object confinement apparatus of the quantum computer; and
helically wrapping a second optical fiber cable around the second cylindrical guide from the first end to the second end of the second cylindrical guide, the second optical fiber cable adapted to deliver laser light generated by the laser to the atomic object confinement apparatus; and
wherein a pitch of the helically wrapped second optical fiber cable is selected to provide a desired effective bend radius of the second optical fiber cable to strip higher-order modes of the laser light.
